(19) United States
(12) Patent Application Publication
(10) Pub. No.: US 2024/0302623 A1
(43) Pub. Date: Sep. 12, 2024

(54) CAMERA DEVICE AND MANUFACTURING METHOD THEREOF

(71) Applicant: Chicony Electronics Co., Ltd., New Taipei City (TW)

(72) Inventors: Li-Hsing Tsai, New Taipei City (TW); Jin-Kae Jang, New Taipei City (TW)

(21) Appl. No.: 18/590,081

(22) Filed: Feb. 28, 2024

(30) Foreign Application Priority Data
Mar. 7, 2023 (TW) 112108375

(51) Int. Cl. G02B 7/02; H04N 23/55

(52) U.S. Cl. CPC G02B 7/023; H04N 23/55

(57) ABSTRACT

A camera device includes a circuit board and a lens holder. The circuit board has a through hole, a first surface, and a second surface opposite to the first surface. The through hole penetrates the first surface and the second surface, and the first surface is provided with a photosensitive element. The lens holder has an axle hole and an assembling surface, and the lens holder includes a welding column. The assembling surface is fixed to the first surface of the circuit board through a light curing adhesive layer, so that the photosensitive element is in the axle hole, the welding column passes through the through hole, and the welding column is welded and fixed to the circuit board. A manufacturing method of camera device is also provided.

### CROSS-REFERENCE TO RELATED APPLICATION

This non-provisional application claims priority under 35 U.S.C. § 119 (a) to Patent Application No. 112108375 filed in Taiwan, R.O.C. on Mar. 7, 2023, the entire contents of which are hereby incorporated by reference.

### BACKGROUND

### Technical Field

The instant disclosure relates to an optical device, in particular, to a camera device and a manufacturing method thereof.

### Related Art

Along with developments of technology, camera devices are widely installed in various electronic products (such as smart phones, tablet computers, cameras, or dashcams) to capture images outside the electronic products.

### SUMMARY

In general, a camera device known to the inventor includes a lens and a circuit board. It is realized that, the fixation between the lens and the circuit board is an important factor regarding whether the image captured by the camera device is clear or not. As to the camera device known to the inventor, the lens and the circuit board are fixed with each other through an adhesive layer. However, when the camera device is subjected to an external force or affected by the environment (such as the temperature or the humidity), the adhesion force of the adhesive layer may be reduced, thus resulting in that the lens is offset with respect to the circuit board or even the lens is detached from the circuit board.

In view of the above, in one embodiment, a camera device is provided. The camera device comprises a circuit board and a lens holder. The circuit board has a through hole, a first surface, and a second surface opposite to the first surface. The through hole penetrates the first surface and the second surface, and the first surface is provided with a photosensitive element. The lens holder has an axle hole and an assembling surface, and the lens holder comprises a welding column. The assembling surface is fixed to the first surface of the circuit board through a light curing adhesive layer, so that the photosensitive element is in the axle hole, the welding column passes through the through hole, and the welding column is welded and fixed to the circuit board.

In another embodiment, a manufacturing method of camera device is provided. The manufacturing method comprises a preparing step: preparing a circuit board, wherein the circuit board has a through hole, a first surface, and a second surface opposite to the first surface, the through hole penetrates the first surface and the second surface, and the first surface is provided with a photosensitive element; an assembling step: placing a lens holder on the first surface of the circuit board, so that a welding column of the lens holder passes through the through hole and protrudes from the second surface, a light curing adhering layer is between an assembling surface of the lens holder and the first surface, and the photosensitive element is in an axle hole of the lens holder; a focus-adjusting step: controlling the lens holder to move with respect to the circuit board, so that the lens holder is in a focused position; a curing step: emitting a light to illuminate the light curing adhering layer, so that the light curing adhering layer is cured to form a light curing adhesive layer; and a welding step: heating the welding column, so that the welding column is welded and fixed to the circuit board.

As above, according to the camera device and the manufacturing method thereof of one or some embodiments of the instant disclosure, when the light curing adhesive layer is subjected to an external force or affected by the environment (such as the temperature or the humidity) such that the adhesion force of the light curing adhesive layer is reduced, through the configuration that the welding column of the lens holder is welded and fixed to the circuit board, the lens holder can be prevented from being offset with respect to the circuit board or detached off the circuit board.

### BRIEF DESCRIPTION OF THE DRAWINGS

The disclosure will become more fully understood from the detailed description given herein below for illustration only, and thus not limitative of the disclosure, wherein:

FIG. 1 illustrates a perspective view of a camera device according to an exemplary embodiment of the instant disclosure;

FIG. 2 illustrates an exploded view of the camera device of the exemplary embodiment of the instant disclosure;

FIG. 3 illustrates a schematic view showing the camera device of the exemplary embodiment of the instant disclosure is in a focus-adjusting step;

FIG. 4 illustrates a schematic view showing the camera device of the exemplary embodiment of the instant disclosure is in a welding step;

FIG. 5 illustrates a cross-sectional view of the camera device of the exemplary embodiment of the instant disclosure;

FIG. 6 illustrates a cross-sectional view of a camera device according to another exemplary embodiment of the instant disclosure; and

FIG. 7 illustrates a flowchart of a manufacturing method of camera device according to an exemplary embodiment of the instant disclosure.

### DETAILED DESCRIPTION

It is noted that, in the embodiments, the terms “first” and “second” are provided to describe different elements, and these elements are not thus limited by using these terms. Furthermore, for the sake of convenience and clarity in the description, thickness or sizes of the elements in the drawings illustrated in an exaggerated, omitted, or general manner are used to help a person skilled in the art with comprehension and reading, and the sizes of the elements are not completely the actual sizes and are not intended to limit any restraint conditions under which the instant disclosure can be implemented and therefore have no technical significance. Any modification to the structures, change to the proportional relationships, or adjustment on the sizes without affecting the effects and the objectives that can be achieved according to the instant disclosure should fall within the scope of the technical content disclosed by the instant disclosure. In all the figures, identical symbols are used to denote identical or similar elements.

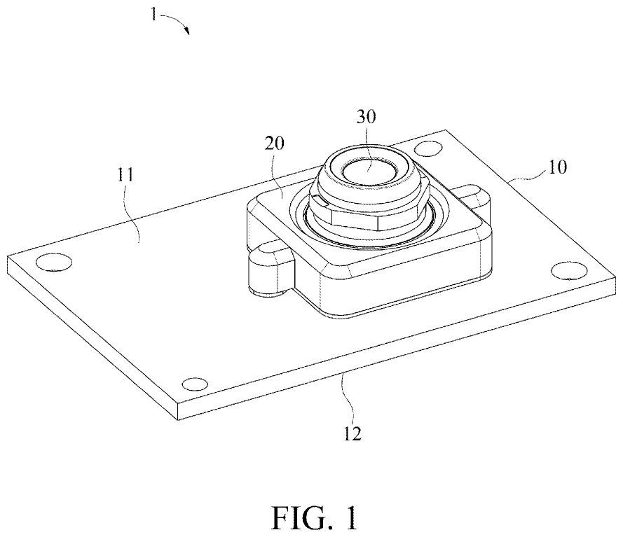

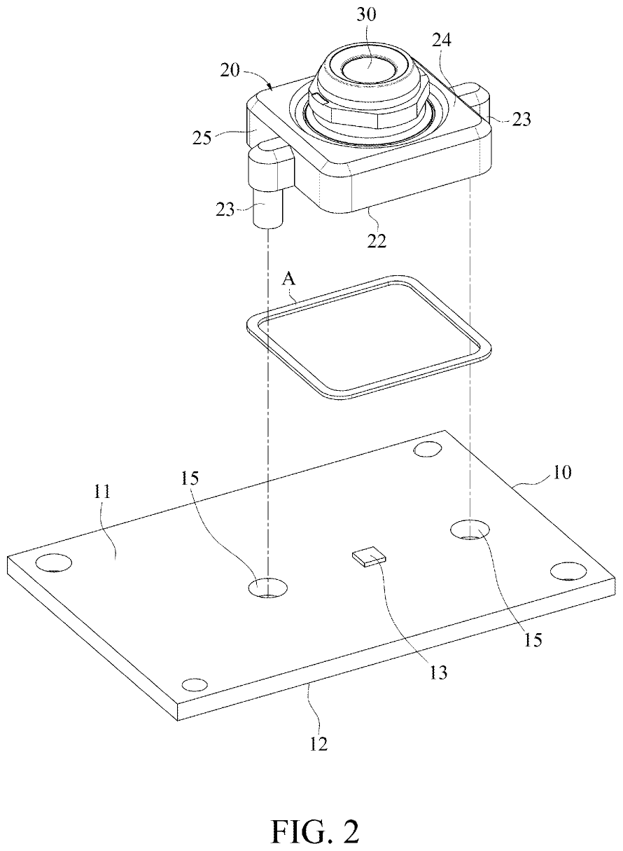

FIG. 1 illustrates a perspective view of a camera device according to an exemplary embodiment of the instant disclosure. FIG. 2 illustrates an exploded view of the camera device of the exemplary embodiment of the instant disclosure. As shown in FIG. 1 and FIG. 2, the camera device 1 comprises a circuit board 10 and a lens holder 20. In some embodiments, the camera device 1 may be utilized in different electronic devices for capturing images or videos around the electronic devices. For example, the camera device 1 may be utilized in automotive products (e.g., dashcams, backup camera systems, or surrounding view systems), mobile devices (e.g., smart phones, tablet computers, or notebook computers), cameras, or other electronic devices.

As shown in FIG. 1 and FIG. 2, the circuit board 10 has at least one through hole 15, a first surface 11, and a second surface 12, where the first surface 11 and the second surface 12 are opposite two surfaces of the circuit board 10. The through hole 15 penetrates the first surface 11 and the second surface 12, and the first surface 11 is provided with a photosensitive element 13. In some embodiments, specifically, the photosensitive element 13 may be a charge-coupled device (CCD), a complementary metal-oxide semiconductor (CMOS), or a CMOS active pixel sensor.

As shown in FIG. 1 and FIG. 2, the lens holder 20 has an assembling surface 22 and comprises at least one welding column 23. The assembling surface 22 of the lens holder 20 is configured to be assembled on the first surface 11 of the circuit board 10, and the welding column 23 is configured to pass through the through hole 15 and to be welded and fixed to the circuit board 10. In the following paragraphs, the steps of the manufacturing method of the camera device 1 according to an exemplary embodiment of the instant disclosure are illustrated with the aids of accompanied drawings.

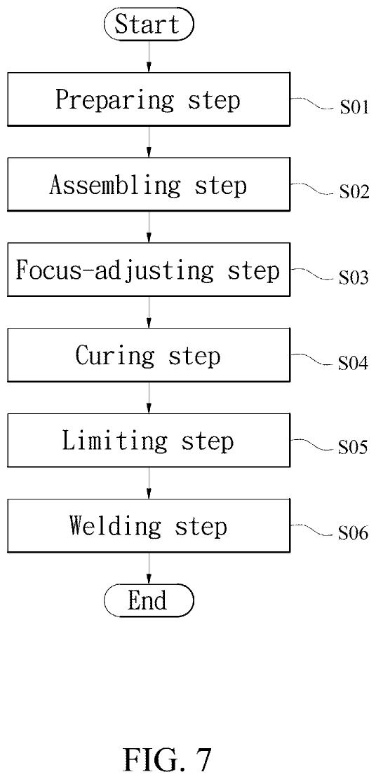

As shown in FIG. 7, FIG. 7 illustrates a flowchart of a manufacturing method of camera device according to an exemplary embodiment of the instant disclosure. A person having ordinary skills in the art can realize that, the manufacturing method of camera device according to the exemplary embodiment of the instant disclosure is not specifically limited to the camera device 1 shown in FIG. 1, and the order of the steps in the manufacturing method is not limited to the order of the flowchart shown in FIG. 7. According to the exemplary embodiment of the instant disclosure, the manufacturing method of the camera device 1 comprises a preparing step S01, an assembling step S02, a focus-adjusting step S03, a curing step S04, a limiting step S05, and a welding step S06. First, refer to FIG. 2 and FIG. 7. In the preparing step S01, a circuit board 10 is prepared. As mentioned above, the circuit board 10 has at least one through hole 15, a first surface 11, and a second surface 12. The through hole 15 penetrates the first surface 11 and the second surface 12, and the first surface 11 is provided with a photosensitive element 13.

As shown in FIG. 2, in this embodiment, the number of the through hole 15 of the circuit board 10 is two, and the two through holes 15 penetrate the first surface 11 and the second surface 12 of the circuit board 10. The two through holes 15 are respectively at two opposite sides of the photosensitive element 13 (and also at two opposite sides of the lens holder 20), so that the two through holes 15 are spaced apart from each other. The number of the welding column 23 of the lens holder 20 is also two so as to correspond to the number of the through hole 15 of the circuit board 10. In some embodiments, the number of the through hole 15 and the number of the welding column 23 may be one or may be three or more. Furthermore, the through hole 15 may be a round hole (as shown in FIG. 2), a square hole, an elliptical hole, or a hole with other shapes; correspondingly, the welding column 23 may be a round column (as shown in FIG. 2), a square column, an elliptical column, or a column with other shapes.

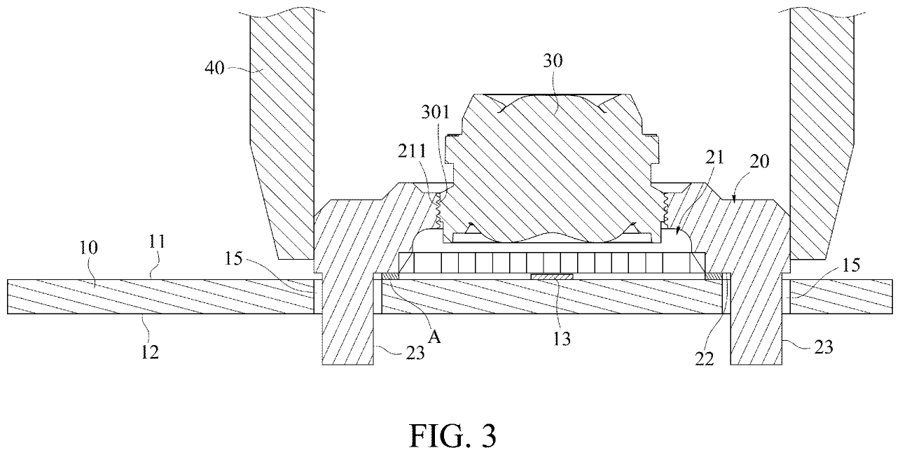

FIG. 3 illustrates a schematic view showing the camera device of the exemplary embodiment of the instant disclosure is in a focus-adjusting step. Refer to FIG. 2, FIG. 3, and FIG. 7. After the preparing step S01, the assembling step S02 can be performed. In the assembling step S02, a lens holder 20 is placed on the first surface 11 of the circuit board 10, so that each of the welding columns 23 of the lens holder 20 passes through a corresponding one of the through holes 15 and protrudes from the second surface 12 of the circuit board 10, a light curing adhering layer A is between the assembling surface 22 of the lens holder 20 and the first surface 11, and the photosensitive element 13 is in an axle hole 21 of the lens holder 20.

As shown in FIG. 2 and FIG. 3, in this embodiment, the lens holder 20 is an annular structure to enclose the axle hole 21, and the assembling surface 22 is an annular surface of the lens holder 20 to be assembled to the circuit board 10. Moreover, a lens 30 may be assembled on one side of the lens holder 20 opposite to the assembling surface 22. In this embodiment, the inner wall of the axle hole 21 has an inner threaded pattern 211, and the lens 30 has an outer threaded pattern 301. The outer threaded pattern 301 of the lens 30 can be locked and fixed with the inner threaded pattern 211 of the axle hole 21, so that the lens 30 and the lens holder 20 are assembled with each other. In some embodiments, the lens 30 and the lens holder 20 may be assembled with each other in other manners (such as engaging or welding).

Continue to refer to FIG. 2, FIG. 3, and FIG. 7. In the preparing step S01, the light curing adhering layer A may be applied on the first surface 11 of the circuit board 10 in advance. Therefore, in the assembling step S02, when the lens holder 20 is placed on the first surface 11 of the circuit board 10, the assembling surface 22 of the lens holder 20 correspondingly contacts the light curing adhering layer A, so that the light curing adhering layer A is between the assembling surface 22 of the lens holder 20 and the first surface 11. As shown in FIG. 2 and FIG. 3, in this embodiment, the light curing adhering layer A is of an annular shape to correspond to the assembling surface 22 of the lens holder 20 which is also of an annular shape, and the light curing adhering layer A is between the photosensitive element 13 and the two through holes 15. Therefore, when the assembling surface 22 of the lens holder 20 contacts the light curing adhering layer A, the photosensitive element 13 is located in the axle hole 21, so that an external light incident from the lens 30 can be collected through the axle hole 21 and thus emitted to the photosensitive element 13. Therefore, the photosensitive element 13 can be prevented from being affected by stray lights.

Refer to FIG. 2, FIG. 3, and FIG. 7 again. After the assembling step S02, the focus-adjusting step S03 can be performed. In the focus-adjusting step S03, the lens holder 20 is controlled to be moved with respect to the circuit board 10, so that the lens holder 20 is in a focused position. Specifically, as shown in FIG. 2 and FIG. 3, in this embodiment, the light curing adhering layer A is in an uncured state. For example, the light curing adhering layer A may include a photoinitiator or a photosensitizer. When the photoinitiator or the photosensitizer is illuminated by a certain light (for example, an ultraviolet (UV) light, an infrared light, or a visible light) to perform photoreactions, the light curing adhering layer A is cured to be in a solid state. It is realized that, the uncured state is that the photoinitiator or the photosensitizer of the light curing adhering layer A is not illuminated by the certain light and thus the light curing adhering layer A is not reacted and not cured. For example, the light curing adhering layer A may be a UV light curing adhering layer; when the light curing adhering layer A is illuminated by the UV light, the light curing adhering layer A is reacted and thus the state of the light curing adhering layer A is changed from the uncured state to the cured state.

Furthermore, as shown in FIG. 3 and FIG. 7, in the focus-adjusting step S03, because the light curing adhering layer A is still in the uncured state, the lens holder 20 can be moved with respect to the circuit board 10 to adjust the position of the lens holder 20. For example, as shown in FIG. 3, a clamp 40 may be applied to hold the lens holder 20, and thus the lens holder 20 is moved with respect to the circuit board 10 to have lifting, shifting, pitching, or yawing movements through the clamp 40, so that the relative position between the lens holder 20 and the photosensitive element 13 can be adjusted to maintain the lens holder 20 at a preset focal length and thus in the focused position.

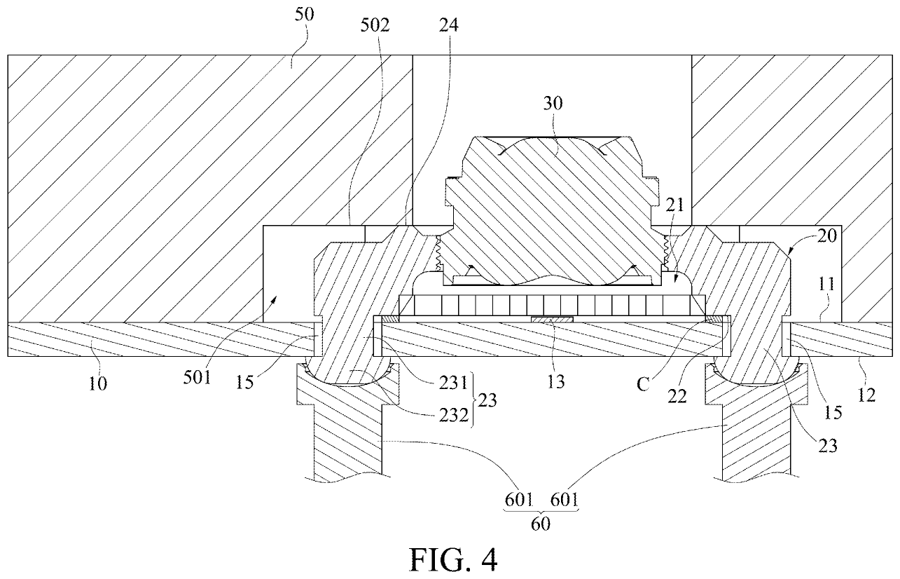

FIG. 4 illustrates a schematic view showing the camera device of the exemplary embodiment of the instant disclosure is in a welding step. Refer to FIG. 3, FIG. 4, and FIG. 7. After the focus-adjusting step S03, the curing step S04 can be performed. In the curing step S04, a light is emitted to illuminate the light curing adhering layer A, so that the light curing adhering layer A is cured to form a light curing adhesive layer C. Specifically, as shown in FIG. 3 and FIG. 4, in some embodiments, after the lens holder 20 is adjusted to the focused position, a certain light (such as the UV light, the infrared light, or the visible light mentioned above) is applied to illuminate the light curing adhering layer A, so that the light curing adhering layer A is cured to form the light curing adhesive layer C, and thus the relative position between the lens holder 20 and the circuit board 10 can be fixed.

Refer to FIG. 4 and FIG. 7. After the curing step S04, the limiting step S05 and the welding step S06 can be performed sequentially. First, in the limiting step S05, a fixture 50 is used to limit the movement of the lens holder 20. Next, in the welding step S06, the welding column 23 of the lens holder 20 is heated, so that the welding column 23 is welded and fixed to the circuit board 10. Specifically, as shown in FIG. 4, in some embodiments, after the light curing adhering layer A is cured to form the light curing adhesive layer C, the fixture 50 may be used firstly to limit the movement of the lens holder 20 and then the welding step is performed subsequently. Therefore, during the welding process, the condition that the lens holder 20 is subjected to an external force so that the lens holder 20 is offset with respect to the circuit board 10 can be prevented. In this embodiment, the fixture 50 has a groove 501, the lens holder 20 can be accommodated in the groove 501, and an inner wall 502 of the groove 501 leans against an outer surface 24 of the lens holder 20 opposite to the assembling surface 22, so that the movement of the lens holder 20 can be limited in advance.

However, it is understood that the order of the steps mentioned above is provided for illustrative purposes. In some embodiments, the welding step S06 can be performed right after the curing step S04, and the instant disclosure is not limited thereto.

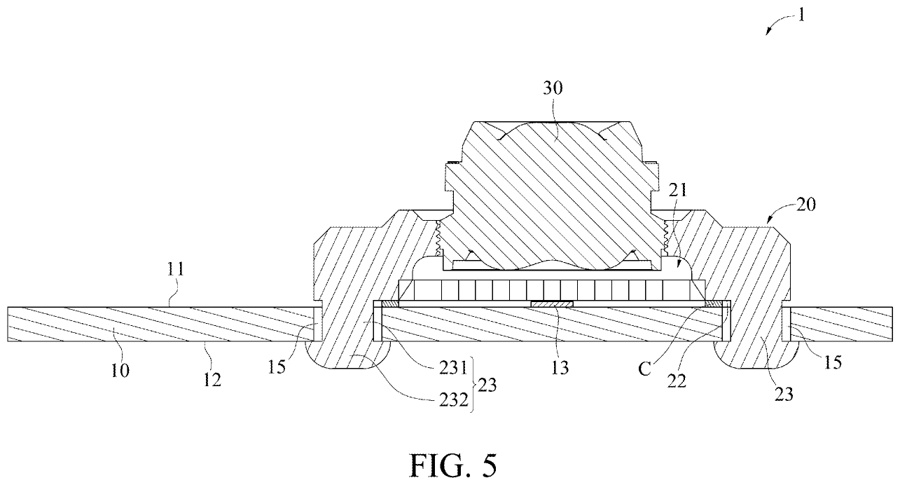

FIG. 5 illustrates a cross-sectional view of the camera device of the exemplary embodiment of the instant disclosure. Refer to FIG. 3 and FIG. 4, the welding column 23 of the lens holder 20 may be made of thermoplastic material(s). In the welding step S06, a heating head 601 of a welding device 60 may be applied to heat an end portion of each of the welding columns 23 protruding from the second surface 12 of the circuit board 10, so that the end portion of each of the welding columns 23 is molten and contacts the second surface 12 of the circuit board 10. Next, as shown in FIG. 5, after each of the welding columns 23 heated by the heating head 601 of the welding device 60 is cooled, each of the welding columns 23 forms a column body 231 and a welding head 232 (in this embodiment, the welding column 23 is of a mushroom shape). The column body 231 is located in the through hole 15, a size of the welding head 232 is greater than a size of the through hole 15, and the welding head 232 is fixed to the second surface 12 of the circuit board 10, so that each of the welding columns 23 passes through a corresponding one of the through holes 15 and is welded and fixed to the circuit board 10, thereby enhancing the fixation between the lens holder 20 and the circuit board 10. Moreover, when the light curing adhesive layer C is subjected to an external force or affected by the environment (such as the temperature or the humidity) such that the adhesion force of the light curing adhesive layer C is reduced, through the configuration that the welding column 23 of the lens holder 20 is welded and fixed to the circuit board 10, the lens holder 20 can be prevented from being offset with respect to the circuit board 10 or detached off the circuit board 10.

As shown in FIG. 2 and FIG. 5, in this embodiment, the lens holder 20 has an outer peripheral portion 25, and two welding columns 23 integrally extend from two opposite sides of the outer peripheral portion 25, respectively. Accordingly, through the configuration that the lens holder 20 is a one-piece structure, the manufacturing costs of the camera device 1 can be reduced and the manufacturing efficiency of the camera device 1 can be increased. Moreover, through the configuration that the two welding columns 23 respectively extend from two opposite sides of the outer peripheral portion 25, the two sides of the lens holder 20 can be positioned uniformly, and the welding columns 23 can be arranged with the photosensitive element 13 as far as possible to prevent the heat for heating the welding columns 23 from affecting the photosensitive element 23 in the welding step S06.

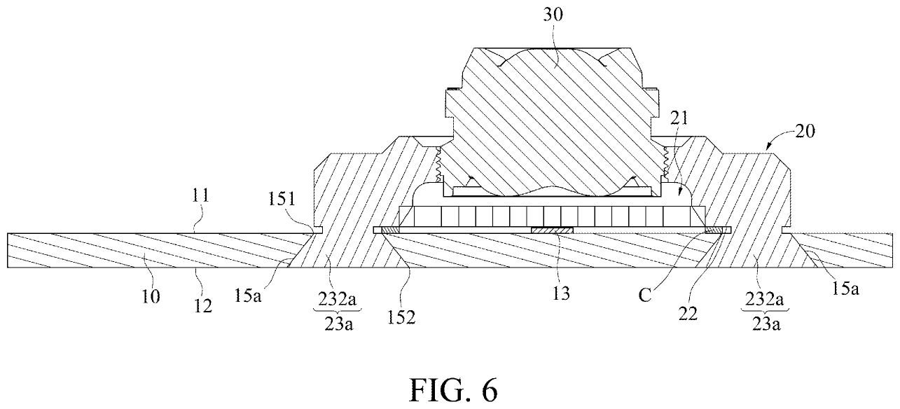

FIG. 6 illustrates a cross-sectional view of a camera device according to another exemplary embodiment of the instant disclosure. As shown in FIG. 6, the difference between this embodiment and the embodiment shown in FIG. 5 is at least that, in this embodiment, each of the through holes 15a of the circuit board 10 has a first opening 151 and a second opening 152 opposite to the first opening 151. The first opening 151 is at the first surface 11, the second opening 152 is at the second surface 12, and a size of the first opening 151 is less than a size of the second opening 152. In other words, in some embodiments, from a cross-sectional view of the through hole 15a, the through hole 15a is gradually expanded from the first surface 11 to the second surface 12. For example, in this embodiment, from a cross-sectional view of the through hole 15a, the through hole 15a is a trapezoidal structure. Accordingly, in the welding step S06, when the heating head 601 of the welding device 60 heats the end portion of each of the welding columns 23a protruding from the second surface 12 of the circuit board 10, the end portion of each of the welding columns 23a can be molten and enter the interior of the corresponding one of the through holes 15a. Next, as shown in FIG. 6, after each of the welding columns 23a is cooled, each of the welding columns 23a forms a welding head 232a, the welding head 232a of each of the welding columns 23a is fixed inside the corresponding one of the through holes 15a, and a shape of the welding head 232a of each of the welding columns 23a corresponds to a shape of the corresponding one of the through holes 15a, thereby enhancing the fixation between the lens holder 20 and the circuit board 10.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A camera device comprising:
a circuit board having a through hole, a first surface, and a second surface opposite to the first surface, wherein the through hole penetrates the first surface and the second surface, and the first surface is provided with a photosensitive element; and
a lens holder having an axle hole and an assembling surface and comprising a welding column, wherein the assembling surface is fixed to the first surface of the circuit board through a light curing adhesive layer, so that the photosensitive element is in the axle hole, the welding column passes through the through hole, and the welding column is welded and fixed to the circuit board.

2. The camera device according to claim 1, wherein the lens holder has an outer peripheral portion, and the welding column integrally extends from the outer peripheral portion.

3. The camera device according to claim 2, wherein the circuit board has a plurality of the through holes, the through holes are at two opposite sides of the lens holder, the lens holder comprises a plurality of the welding columns, the welding columns respectively extends from two opposite sides of the outer peripheral portion, and each of the welding columns passes through a corresponding one of the through holes and is welded and fixed to the circuit board.

4. The camera device according to claim 1, wherein the welding column comprises a column body and a welding head, the column body is in the through hole, a size of the welding head is greater than a size of the through hole, and the welding head is fixed to the second surface of the circuit board.

5. The camera device according to claim 1, wherein the through hole has a first opening and a second opening opposite to the first opening, the first opening is at the first surface, the second opening is at the second surface, a size of the first opening is less than a size of the second opening, the welding column comprises a welding head, and the welding head is fixed inside the through hole.

6. A manufacturing method of camera device comprising:
a preparing step: preparing a circuit board, wherein the circuit board has a through hole, a first surface, and a second surface opposite to the first surface, the through hole penetrates the first surface and the second surface, and the first surface is provided with a photosensitive element;
an assembling step: placing a lens holder on the first surface of the circuit board, so that a welding column of the lens holder passes through the through hole and protrudes from the second surface, a light curing adhering layer is between an assembling surface of the lens holder and the first surface, and the photosensitive element is in an axle hole of the lens holder;
a focus-adjusting step: controlling the lens holder to move with respect to the circuit board, so that the lens holder is in a focused position;
a curing step: emitting a light to illuminate the light curing adhering layer, so that the light curing adhering layer is cured to form a light curing adhesive layer; and
a welding step: heating the welding column, so that the welding column is welded and fixed to the circuit board.

7. The manufacturing method of camera device according to claim 6, wherein the manufacturing method further comprises a limiting step after the curing step and before the welding step, and the limiting step comprises: limiting a movement of the lens holder by using a fixture.

8. The manufacturing method of camera device according to claim 6, wherein the preparing step further comprises: applying the light curing adhering layer on the first surface of the circuit board.

9. The manufacturing method of camera device according to claim 6, wherein in the welding step, the welding column comprises a column body and a welding head, the column body is in the through hole, a size of the welding head is greater than a size of the through hole, and the welding head is fixed to the second surface of the circuit board.

10. The manufacturing method of camera device according to claim 6, wherein in the preparing step, the through hole has a first opening and a second opening opposite to the first opening, the first opening is at the first surface, the second opening is at the second surface, a size of the first opening is less than a size of the second opening; in the welding step, the welding column comprises a welding head, and the welding head is fixed inside the through hole.
